(19) United States
(12) Patent Application Publication
(10) Pub. No.: US 2026/0062014 A1
(43) Pub. Date: Mar. 5, 2026

(54) APPARATUS AND METHOD FOR DIAGNOSTIC COMMUNICATION IN A VEHICLE AND A VEHICLE INCLUDING THE SAME

(71) Applicants: HYUNDAI MOTOR COMPANY, Seoul (KR); KIA CORPORATION, Seoul (KR)

(72) Inventors: Jae Hun Lee, Hwaseong-si (KR); In Jun Ko, Hwaseong-si (KR)

(73) Assignees: HYUNDAI MOTOR COMPANY, Seoul (KR); KIA CORPORATION, Seoul (KR)

(21) Appl. No.: 19/046,009

(22) Filed: Feb. 5, 2025

(30) Foreign Application Priority Data
Sep. 3, 2024 (KR) 10-2024-0119110

(51) Int. Cl. B60W 50/02

(52) U.S. Cl. CPC B60W 50/0205; B60W 2556/45

(57) ABSTRACT

A method for diagnostic communication in a vehicle, includes: an operation of checking whether there is a previously connected channel facing a lower level of one of a plurality of communication nodes according to a first protocol, by one of the plurality of communication nodes in the vehicle, when a protocol of a received message received from an upper level corresponds to a second protocol; and a selective channel connection operation of selectively connecting a channel facing a lower level of one of the plurality of communication nodes, depending on a check result in the operation of checking, by one of the plurality of communication nodes.

### CROSS-REFERENCE TO RELATED APPLICATION(S)

This application claims the benefit of priority to Korean Patent Application No. 10-2024-0119110 filed on Sep. 3, 2024 in the Korean Intellectual Property Office, the disclosure of which is incorporated herein by reference in its entirety.

### BACKGROUND

### Technical Field

The present disclosure relates to a method and an apparatus for diagnostic communication in a vehicle, and a vehicle including the same.

### Description of Related Art

With the development of vehicle technology, vehicles may include various electronic control modules, and the electronic control modules may control various devices or systems mounted in the vehicles. Examples of electronic control modules may include an engine control module (engine control unit, ECU), a transmission control module (transmission control unit, TCU), an airbag control module (airbag control unit, ACU), an antilock braking system (antilock braking system, ABS) module, a measuring instrument and driver information module, and the like.

The electronic control modules may be connected through a vehicle network, may monitor various control inputs and operating parameters transmitted through the vehicle network, and may control devices or systems accordingly. For example, an engine control module (ECM) may receive accelerator pedal deflation as an input to control an ignition and fuel system of an engine. In addition, the engine control module (ECM) may monitor a speed, a torque, and other operating parameters of the engine to optimize performance of the engine. Some control or operating parameters monitored by one module may be requested by one or more other modules. For example, an engine speed monitored by the engine control module may be requested by the transmission control module, a brake release module, and a measuring instrument and driver information module. Additionally, a wheel speed monitored by the antilock braking system module may be used by the engine control module and the transmission control module for traction control purposes.

Since the electronic control module may be disposed in the vehicle, a vehicle diagnostic device (e.g., on-board diagnostics device) may communicate with the electronic control module via the vehicle network (e.g., Ethernet) according to a diagnostic communication protocol (e.g., diagnostics over internet protocol (DoIP)), to diagnose the electronic control module.

### SUMMARY

A channel between a plurality of communication nodes of a vehicle network may use a resource of the vehicle network in a connected state. As an amount of overall resource usage of the vehicle network increases, a possibility of communication failure/delay in the vehicle network may increase. As unnecessary connection state maintenance of a plurality of channels is reduced, the amount of overall resource usage of the vehicle network may be reduced, and the possibility of communication failure/delay in the vehicle network may be lowered. As compared to a single protocol, when the vehicle network is based on a plurality of protocols (e.g., Ethernet, CAN, DoIP, DoCAN), difficulty of reducing the unnecessary connection state maintenance of the plurality of channels may be higher.

According to an embodiment of the present disclosure, a method and an apparatus for diagnostic communication in a vehicle, and a vehicle including the same, may provide a diagnostic environment in which the plurality of protocols for diagnosing an electronic control module may be efficiently and stably utilized by reducing unnecessary connection state maintenance of the plurality of channels or efficiently reducing overall resource usage of the vehicle network, even when the plurality of protocols (e.g., Ethernet, CAN, DoIP, DoCAN) are used for diagnosing the electronic control module.

According to an aspect of the present disclosure, a method for diagnostic communication in a vehicle includes: an operation of checking whether there is a previously connected channel facing a lower level of one of a plurality of communication nodes according to a first protocol, by one of the plurality of communication nodes in the vehicle, when a protocol of a received message received from an upper level corresponds to a second protocol; and a selective channel connection operation of selectively connecting a channel facing a lower level of one of the plurality of communication nodes, depending on a check result in the operation of checking, by one of the plurality of communication nodes.

According to another aspect of the present disclosure, an apparatus for diagnostic communication in a vehicle includes: an edge communication node configured for receiving a message from a source external of the vehicle and protocol-converting or routing the message; and a control communication node configured for receiving the message protocol-converted or routed by the edge communication node, wherein, when a protocol of a received message received from an upper level corresponds to a second protocol, at least one of the edge communication node or the control communication node is configured to check whether there is a previously connected channel facing a lower level according to a first protocol, and to selectively connect a channel facing a lower level, depending on a check result.

According to another aspect of the present disclosure, a vehicle includes a computing device having a processor and a storage medium storing one or more programs configured to be executable by the processor, wherein the one or more programs include commands for executing the method described above (i.e., the method of claim 1).

### BRIEF DESCRIPTION OF DRAWINGS

The above and other aspects, features, and advantages of the present disclosure are more clearly understood from the following detailed description, taken in conjunction with the accompanying drawings, in which:

FIG. 1 is a view illustrating a specific implementation of a method and an apparatus for diagnostic communication in a vehicle, and the vehicle, according to an embodiment of the present disclosure.

FIGS. 2A and 2B are block diagrams illustrating a plurality of nodes of a method and an apparatus for diagnostic communication in a vehicle, according to an embodiment of the present disclosure.

FIG. 3 is a view illustrating automatic channel connection according to a first protocol of a method and an apparatus for diagnostic communication in a vehicle, according to an embodiment of the present disclosure.

FIGS. 4A, 5A, and 6A are views illustrating selective channel connection according to message reception corresponding to a second protocol of a method and an apparatus for diagnostic communication in a vehicle, according to an embodiment of the present disclosure.

FIGS. 4B, 5B, and 6B are views illustrating differences in time points of disconnection between plurality of channels according to message reception corresponding to a second protocol of a method and an apparatus for diagnostic communication in a vehicle, according to an embodiment of the present disclosure.

FIGS. 7 and 8 are flowcharts illustrating a method for diagnostic communication in a vehicle, according to an embodiment of the present disclosure.

### DETAILED DESCRIPTION

Since the present disclosure may have various changes and may have various embodiments, specific embodiments are illustrated in the drawings and described in detail. However, this is not intended to limit the present disclosure to specific embodiments, and it should be understood to include all modifications, equivalents, and substitutes included in the spirit and scope of the present disclosure.

Terms such as first, second, and the like may be used to describe various elements, but the elements should not be limited by the terms. The above terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments, and may not be intended to limit the present disclosure. The singular expression may include the plural expression unless the context clearly dictates otherwise. In the present application, terms such as “comprise,” “include,” “have,” and the like are intended to designate that a feature, a number, an operation, an operation, a component, a part, or a combination thereof described in the specification exists, but it should be understood that existence or addition of one or more other features, numbers, operations, operations, components, parts, or combinations thereof are excluded in advance.

Unless defined otherwise, all terms used herein, including technical or scientific terms, have the same meaning as commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present disclosure.

In this specification, a vehicle (including an electric vehicle) means various vehicles that move a transport object such as a person, an animal, an object, or the like from a starting point to a destination. Such vehicles are not limited to vehicles that run on roads or tracks.

When a component, device, element, or the like of the present disclosure is described as having a purpose or performing an operation, function, or the like, the component, device, or element should be considered herein as being “configured to” meet that purpose or to perform that operation or function.

Hereinafter, with reference to the attached drawings, an embodiment of the present disclosure is described in more detail.

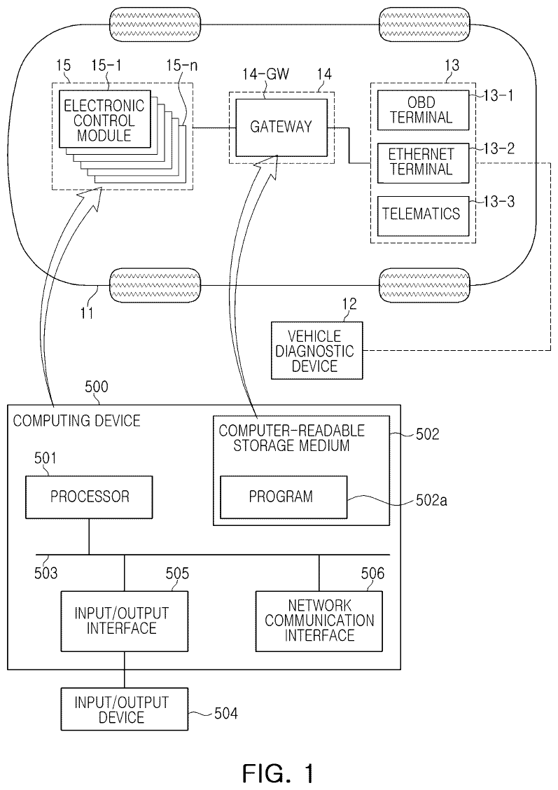

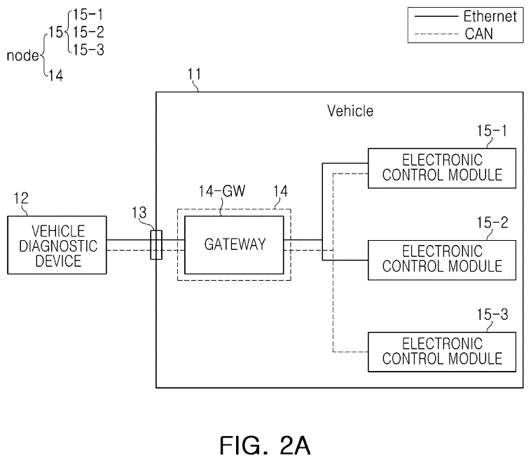

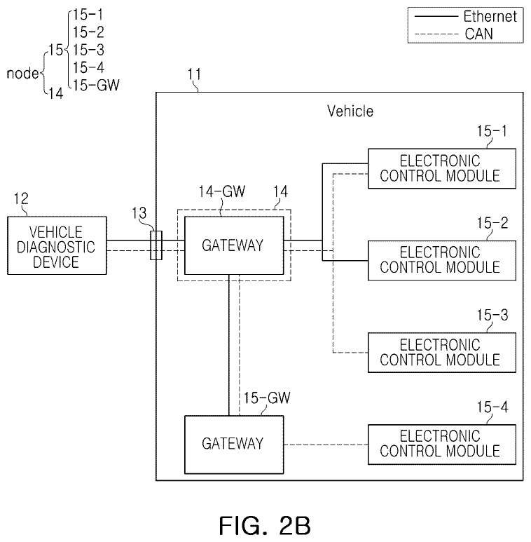

FIG. 1 is a view illustrating a specific implementation of a method and an apparatus for diagnostic communication in a vehicle, according to an embodiment of the present disclosure, and the vehicle. Referring to FIG. 1, FIG. 2A, and FIG. 2B, a vehicle 11 may include a plurality of electronic control modules 15-1 through 15-n capable of collecting, providing, and transmitting information necessary for driving, information required during driving, or information for enhancing driving safety to a user, a driver, or a passenger.

The plurality of electronic control modules 15-1 through 15-n may be connected to each other through a vehicle network to exchange data. The plurality of electronic control modules 15-1 through 15-n may include an information collection device such as a sensor, a camera, or the like, as well as an information collection device capable of generating and processing new information by performing calculations according to a preset program and a preset function, based on collected information, or the like.

For example, each of the plurality of electronic control modules 15-1 through 15-n may be implemented as an electronic control unit (ECU) that controls various devices included in the vehicle. The ECU may be implemented as an ECU that controls an infotainment device (e.g., display device, a navigation device, an around view monitoring device, or the like), and may be implemented as an engine control unit, a transmission control unit, an engine management system electronic control unit (EMS ECU), a transmission management system electronic control unit (TMS ECU), an airbag control module (airbag control unit, ACU), an anti-locking brake system electronic control unit (ABS ECU), or a measuring instrument and driver information module.

The plurality of electronic control modules 15-1 through 15-n may be connected to each other through a hierarchical network structure via an edge gateway 14-GW. The edge gateway 14-GW may include a computer or a software that enables communication between networks using different communication networks and protocols in a vehicle network, may be a network point that acts as an entrance to different networks, and may also act as a passage between different types of networks.

The vehicle 11 may include an edge gateway 14-GW, and the number of edge gateways 14-GW included in the vehicle 11 may be determined in accordance with the number and connection type of the plurality of electronic control modules 15-1 through 15-n mounted on the vehicle 11.

A vehicle diagnostic device 12 for diagnosing the plurality of electronic control modules 15-1 through 15-n mounted on the vehicle 11 may be connected to or interworked with the vehicle 11. The vehicle diagnostic device 12 may diagnose the plurality of electronic control modules 15-1 through 15-n connected through a plurality of different communication methods of vehicle network. The vehicle diagnostic device 12 may be in the form of a terminal device that may be physically separated from the vehicle 11 but may be connected through terminals mounted on the vehicle 11. In addition, according to an embodiment, the vehicle diagnostic device 12 may be in the form of a network server that may check the plurality of electronic control modules 15-1 through 15-n mounted on the vehicle 11 and may collect data through a wired/wireless communication network.

There may be an input/output means 13 between the vehicle diagnostic device 12 and the edge gateway 14-GW that transmits data to perform a diagnostic process and collect results therefrom. For example, the input/output means 13 may include an on-board diagnostics (OBD) terminal 13-1 mounted on the vehicle 11. In this case, on-board diagnostics (OBD) refers to a diagnostic standard for checking and controlling an electrical/electronic operation status of the vehicle 11. Initially, OBD was used to improve maintenance efficiency of electronic components such as an engine or the like, but in addition to this purpose, OBD also serves as an interface as a trip computer that shows various vehicle information to the driver.

As the number of the plurality of electronic control modules 15-1 through 15-n mounted on the vehicle 11 increases and an amount of data transmitted and received by the plurality of electronic control modules 15-1 through 15-n increases, both controller area network (CAN) communication and Ethernet communication may be applied to the vehicle network. For example, a maximum transmission bandwidth of CAN communication, which may be a controller area network, may be 1 Mbps. At this speed, when the number of plurality of electronic control modules 15-1 through 15-n in the vehicle 11 increases and data traffic increases rapidly due to real-time video transmission (e.g., Topview monitoring) or the like, there may be limitations in configuring the vehicle network using only CAN communication. A data transmission rate of CAN-FD may be up to 2 Mbit/s in a multi-drop network and up to 5 Mbit/s in point-to-point communication, and in Ethernet, a speed of 1 Gbps may be also proposed. Therefore, in a process of checking and controlling the electrical/electronic operation status of the vehicle 11, the vehicle diagnostic device 12 may be connected via an Ethernet terminal 13-2.

Depending on a design, the input/output means 13 may use a telematics device 13-3 mounted on the vehicle 11. The telematics device 13-3 may be an example of a device that may provide comprehensive multimedia services for vehicles using location information and wireless communication networks, may provide safe driving, emergency rescue, traffic information services, or the like to the driver, and may provide infotainment services such as the Internet, movies, games, and multimedia to the passenger. In addition, the telematics device 13-3 may transmit a diagnostic message for checking and collecting data from the plurality of electronic control modules 15-1 through 15-n mounted on the vehicle 11 by linking with a network server for diagnosing the operation of devices in the vehicle 11, and may transmit the data transmitted from the plurality of electronic control modules 15-1 through 15-n mounted on the vehicle 11 to the network server.

The diagnostic message that may be transmitted through the edge gateway 14-GW may be transmitted through a user datagram protocol (UDP) and/or a transmission control protocol (TCP) among transport layer protocols. For example, for vehicle diagnosis (diagnostic access), a diagnostic protocol (diagnostics over IP, DoIP) based on IEEE 802.3 and IPv4/IPv6 may be used, and a diagnostic protocol (diagnostics over CAN, DoCAN) based on CAN may be used.

A system for vehicle diagnosis may include at least one of a message generator that generates a diagnostic message for diagnosing the plurality of electronic control modules 15-1 through 15-n mounted on the vehicle 11, or a message receiver that recognizes the diagnostic message. The message generator and/or the message receiver may be included in each of the plurality of electronic control modules 15-1 through 15-n, the vehicle diagnostic device 12, and the edge gateway 14-GW.

The plurality of electronic control modules 15-1 through 15-n may communicate with devices connected to other vehicle networks via the edge gateway 14-GW, and the edge gateway 14-GW may perform a switching role for the plurality of vehicle networks. The edge gateway 14-GW may be an interface between the plurality of electronic control modules 15-1 through 15-n. For example, the edge gateway 14-GW that transmits messages and signals according to a diagnostic protocol (e.g., DoIP, DoCAN) for networking with the vehicle diagnostic device 12 based on Ethernet/IP may provide scheduling and protocol conversion functions for interworking with the plurality of electronic control modules 15-1 through 15-n.

For example, a plurality of communication nodes forming the vehicle network may be connected as a star topology, a bus topology, a ring topology, a tree topology, a mesh topology, or the like, but are not limited thereto. For example, each of the plurality of communication nodes forming the vehicle network may support a CAN protocol, a FlexRay protocol, a MOST protocol, a LIN protocol, an Ethernet protocol, or the like, but is not limited thereto.

For example, each of the plurality of communication nodes may include layers 1 to 7. The layer 1 may support a PHY function and may support a transmission speed of 100 Mbps (megabit per second). The layer 2 may support an IEEE 802.10 protocol, an IEEE 802.1p protocol, an IEEE 802.3 protocol, an audio video bridging (AVB) protocol (e.g., IEEE 802.1Qav protocol, IEEE 802.1Qat protocol), or the like. The layer 3 may support an internet protocol version 4 (IPv4), an address resolution protocol (ARP), an internet control message protocol version 4 (ICMPv4), IEEE 802.1AS, IEEE 1722, or the like. The layer 4 may support a transfer control protocol (TCP), a user datagram protocol (UDP), IEEE 802.1AS, IEEE 1722, or the like. The layers 5 to 7 may support a diagnostics over internet protocol (DoIP), a diagnostics over CAN (DoCAN), an EthCC protocol, a dynamic host configuration protocol (DHCP), an SD protocol, a network management (NM) protocol, IEEE 802.1AS, IEEE 1722, or the like.

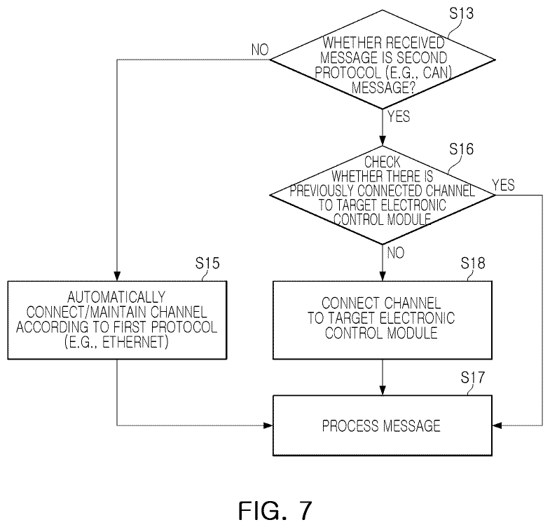

FIGS. 2A and 2B are block diagrams illustrating a plurality of nodes of a method and an apparatus for diagnostic communication in a vehicle, according to an embodiment of the present disclosure. FIG. 7 is a flowchart illustrating a method for diagnostic communication in a vehicle according to an embodiment of the present disclosure.

Referring to FIGS. 2A and 2B, a plurality of communication nodes may include an edge communication node 14 and a control communication node 15. The edge communication node 14 may include an edge gateway 14-GW, and the control communication node 15 may include a plurality of electronic control modules 15-1, 15-2, 15-3, and 15-4. Referring to FIG. 2B, the control communication node 15 may further include a control gateway 15-GW.

Each of the plurality of electronic control modules 15-1, 15-2, 15-3, and 15-4 may be one of the plurality of communication nodes, and each of the control gateway 15-GW and the edge gateway 14-GW may be one of the plurality of communication nodes. The edge gateway 14-GW may be a lower level of a source external of the vehicle 11 (e.g., vehicle diagnostic device 12), and may be upper levels of the plurality of electronic control modules 15-1, 15-2, 15-3, and 15-4 and the control gateway 15-GW. The control gateway 15-GW may be a lower level of the edge gateway 14-GW, and may be an upper level of the electronic control module 15-4. For example, the plurality of communication nodes may have a hierarchical structure from an upper level to a lower level.

An apparatus for diagnostic communication in a vehicle, according to an embodiment of the present disclosure, may include an edge communication node 14 that receives a message from a source external of the vehicle 11 (e.g., vehicle diagnostic device 12) and protocol-converts or routes the message, and a control communication node 15 that receives a message protocol-converted or routed by the edge communication node 14. For example, an edge gateway 14-GW of the edge communication node 14 may perform protocol conversion between a first protocol (e.g., Ethernet, DoIP) and a second protocol (e.g., CAN, DoCAN) for the message transmitted and received between the vehicle diagnostic device 12 and the control communication node 15, or may perform simple routing without protocol conversion.

Since various types of a plurality of electronic control modules 15-1 through 15-n may be provided and the number of the plurality of electronic control modules 15-1 through 15-n may be large, types/number of communications that may be respectively supported by a plurality of electronic control modules 15-1, 15-2, 15-3, and 15-4 may be different from each other, and types/number of protocols that may be supported may also be different from each other. For example, an electronic control module 15-1 and a control gateway 15-GW may support both Ethernet communication and CAN communication, and may support both a diagnostics over internet protocol (DoIP) based on Ethernet and a diagnostics over CAN (DoCAN) based on CAN. An electronic control module 15-2 may support only the Ethernet communication among the Ethernet communication and the CAN communication, and may support only DoIP among the DoIP and the DoCAN. Electronic control modules 15-3 and 15-4 may support only the CAN communication among the Ethernet communication and the CAN communication, and may support only the DoCAN among the DoIP and the DoCAN.

Depending on a design, a plurality of protocols may be based on not only the Ethernet and the CAN, but also a CAN with flexible data-rate (CAN-FD), local interconnect network (LIN) communication, media oriented systems transport (MOST) communication, or the like, and may be replaced by the CAN-FD, the LIN communication, the MOST communication, but are not limited thereto.

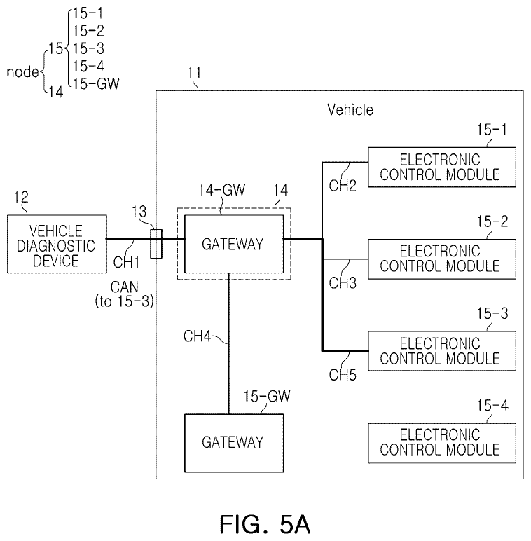

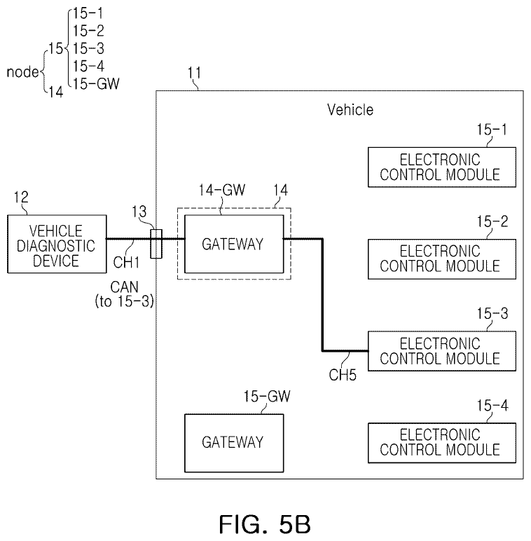

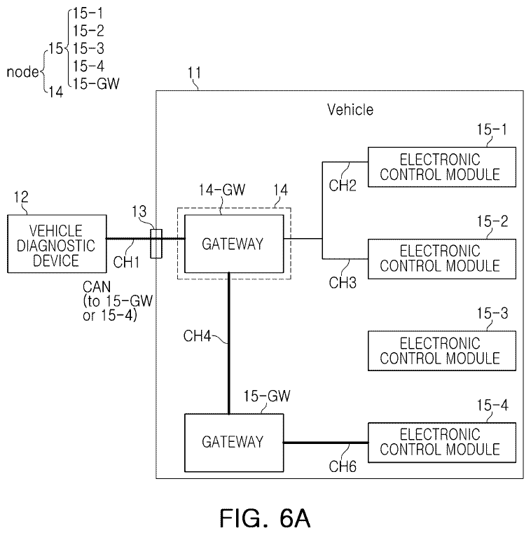

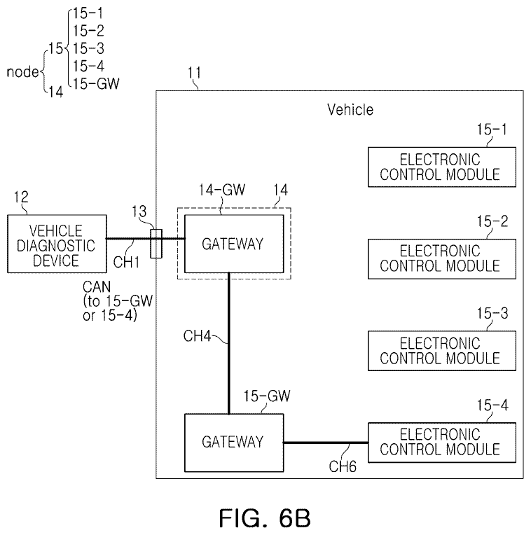

Each of the plurality of channels (CH1, CH2, CH3, CH4, and CH5 in FIG. 5A and CH6 in FIG. 6A) connected between the plurality of communication nodes may use a resource of a vehicle network in a connected state. As an amount of overall resource usage of the vehicle network increases, possibility of communication failure/delay in the vehicle network may increase.

As the unnecessary connection state maintenance of the plurality of channels (CH1, CH2, CH3, CH4, and CH5 in FIG. 5A and CH6 in FIG. 6A) is reduced, the amount of overall resource usage of the vehicle network (including a transport control protocol (TCP) connection resource) may be reduced, and the possibility of communication failure/delay in the vehicle network may be lowered.

However, as compared to a single protocol, when the vehicle network is based on a plurality of protocols (e.g., Ethernet, CAN, DoIP, DoCAN), difficulty of reducing the unnecessary connection state maintenance of the plurality of channels may be higher. For example, among a plurality of protocols (e.g., Ethernet, CAN, DoIP, DoCAN), compatibility (e.g., operation collision avoidance) of one procedure may be limited with another procedure, and compatibility limitations of the plurality of protocols may increase the difficulty of reducing unnecessary connection state maintenance of the plurality of channels.

Referring to FIG. 2A and FIG. 7, a method for diagnostic communication in a vehicle according to an embodiment of the present disclosure may include an operation (S16) of checking whether there is a previously connected channel facing a lower level of one of a plurality of communication nodes according to a first protocol (e.g., Ethernet, DoIP), by one of the plurality of communication nodes in the vehicle, when a protocol of a received message received from an upper level corresponds to a second protocol (e.g., CAN, DoCAN). The method may also include a selective channel connection operation (S18) of selectively connecting a channel facing a lower level of one of the plurality of communication nodes, depending on a check result in the operation (S16) of checking, by one of the plurality of communication nodes. For example, a channel connection procedure according to the second protocol (e.g., CAN, DoCAN) may be supplementary to a channel connection procedure according to the first protocol (e.g., Ethernet, DoIP).

Therefore, a method and an apparatus for diagnostic communication in a vehicle according to an embodiment of the present disclosure may clearly provide a connection procedure and/or a disconnection procedure of a plurality of channels, such that the plurality of channels (CH1, CH2, CH3, CH4, CH5 of FIG. 5A and CH6 of FIG. 6A) may be efficiently used even in a vehicle network based on a plurality of protocols (e.g., Ethernet, CAN, DoIP, DoCAN), such that usage stability (e.g., operation collision prevention) and efficiency (e.g., unnecessary resource usage prevention) of the plurality of channels in the vehicle network.

For example, one of the plurality of communication nodes may use a channel connection procedure according to the first protocol (e.g., Ethernet, Do IP) as a main/comprehensive channel connection procedure, and may use a channel connection procedure according to the second protocol (e.g., CAN, DoCAN) as a supplementary/individual channel connection procedure. Since the main/comprehensive channel connection procedure and the supplementary/individual channel connection procedure may be complementary to each other, compatibility between the channel connection procedure according to the first protocol (e.g., Ethernet, DoIP) and the channel connection procedure according to the second protocol (e.g., CAN, DoCAN) may be high. Therefore, a method and an apparatus for diagnostic communication in a vehicle according to an embodiment of the present disclosure may effectively improve usage stability (e.g., operation collision prevention) and efficiency (e.g., unnecessary resource usage prevention) of the plurality of channels in the vehicle network based on the plurality of protocols (e.g., Ethernet, CAN, DoIP, DoCAN), and may omit a separate monitoring means for determining whether to maintain channel connection.

Referring to FIG. 2A and FIG. 7, a method for diagnostic communication in a vehicle according to an embodiment of the present disclosure may further include an operation (S13) identifying a protocol of a received message received from an upper level by one of the plurality of communication nodes. For example, among the plurality of communication nodes, at least one of the edge gateway 14-GW of the edge communication node 14 and the control gateway 15-GW of the control communication node 15 may determine whether to protocol-convert or route a received message into a protocol. For this determination, the protocol may be identified, and the protocol may also be identified to determine whether to execute the operation (S16) of checking and the selective channel connection operation (S18).

Referring to FIG. 2A and FIG. 7, a method for diagnostic communication in a vehicle according to an embodiment of the present disclosure may further include an operation (S17) of processing a received message by one of the plurality of communication nodes. For example, the processing the message may be implemented as at least one of, but not limited to, processing of a vehicle identification request, processing of a vehicle identification response, processing of a vehicle announcement message, processing of routing activation, processing of an alive check, processing of a DoIP entity status, processing of diagnostic power mode information, or processing of a diagnostic message.

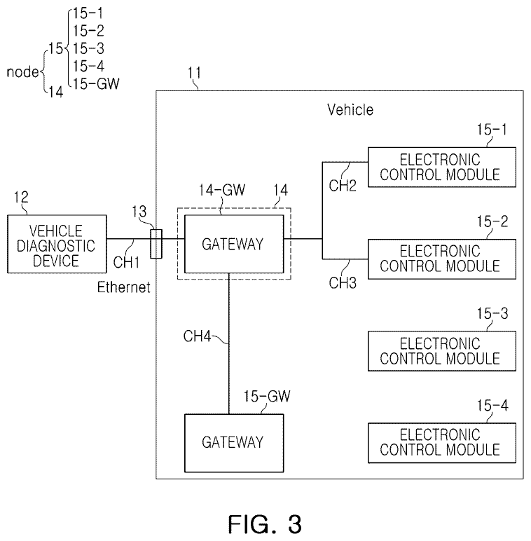

FIG. 3 is a view illustrating automatic channel connection according to a first protocol of a method and an apparatus for diagnostic communication in a vehicle, according to an embodiment of the present disclosure. Referring to FIG. 3 and FIG. 7, a method for diagnostic communication in a vehicle according to an embodiment of the present disclosure may further include an automatic channel connection operation (S15) of automatically connecting a channel (CH2, CH3, and CH4) to face a lower level of one of a plurality of communication nodes according to a first protocol (e.g., Ethernet, DoIP) by one of the plurality of communication nodes, when a protocol of a received message from an upper level corresponds to the first protocol (e.g., Ethernet, DoIP).

For example, a source external of the vehicle 11 (e.g., vehicle diagnostic device 12) may connect a channel CH1 to face an edge communication node 14 through an input/output means 13 to transmit a message to the edge communication node 14. Thereafter, the edge communication node 14 may identify a received message from the external source of the vehicle 11 (e.g., vehicle diagnostic device 12), and when the received message corresponds to the first protocol (e.g., Ethernet, DoIP), a control communication node 15 may be connected to pre-selected communication nodes (e.g., electronic control modules 15-1 and 15-2, control gateway 15-GW) through a plurality of pre-selected channels CH2, CH3, and CH4. Automatic channel connection may mean that the edge communication node 14 does not select which channel to connect among the plurality of channels CH2, CH3, and CH4 that may be connected to a lower level, and may mean that it does not check whether there is a previously connected channel among the plurality of channels CH2, CH3, and CH4.

The plurality of channels CH2, CH3, and CH4 may be connected later than a channel CH1 (i.e., after a connection of channel CH1). The plurality of channels CH2, CH3, and CH4 may be radio-connected according to the connection of the channel CH1. After the connection of the channel CH4, when there is a communication node that may support the first protocol (e.g., Ethernet, DoIP) on a lower level, the control gateway 15-GW may connect a channel facing the communication node.

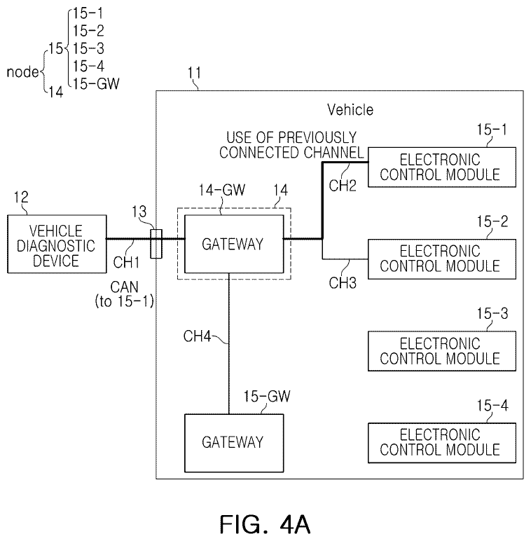

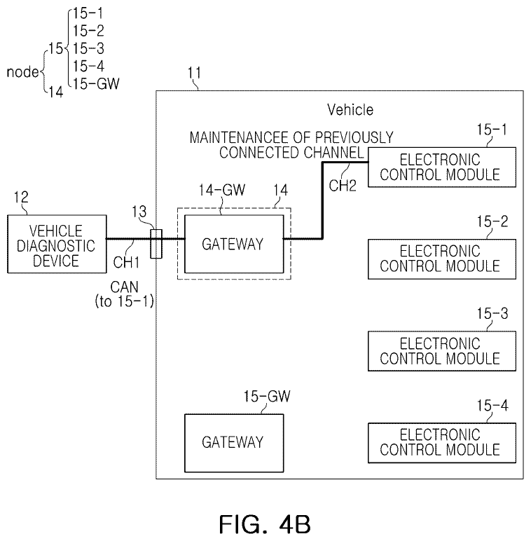

FIGS. 4A, 5A, and 6A are views illustrating selective channel connection according to message reception corresponding to a second protocol of a method and an apparatus for diagnostic communication in a vehicle, according to an embodiment of the present disclosure.

Referring to FIGS. 4A, 5A, 6A, and 7, when a protocol of a received message corresponds to a first protocol (e.g., Ethernet, DoIP), an automatic channel connection operation (S15) may include automatically connecting all channels CH2, CH3, and CH4 to a plurality of communication nodes (e.g., electronic control modules 15-1 and 15-2, control gateways 15-GW) capable of supporting the first protocol (e.g., Ethernet, DoIP) on a lower level of one of the plurality of communication nodes.

When a protocol of a received message corresponds to a second protocol (e.g., CAN, DoCAN), a selective channel connection operation (S18) may include selecting a portion of communication nodes (e.g., electronic control modules 15-2, 15-3, and 15-4) capable of supporting the second protocol (e.g., CAN, DoCAN) on a lower level of one of the plurality of communication nodes, and connecting a channel (one of CH3, CH5, and CH6).

When a protocol of a received message corresponds to a second protocol (e.g., CAN, DoCAN), a selective channel connection operation (S18) may include selecting a target communication node of the received message among a plurality of communication nodes (e.g., electronic control modules 15-2, 15-3, and 15-4) capable of supporting the second protocol (e.g., CAN, DoCAN) on a lower level of one of the plurality of communication nodes, and connecting a channel (one of CH3, CH5, and CH6).

Referring to FIG. 4A, a target communication node (to 15-1) of a received message of an edge communication node 14 may be an electronic control module 15-1, and may select the electronic control module 15-1 among communication nodes (e.g., electronic control modules 15-2, 15-3, and 15-4) capable of supporting a second protocol (e.g., CAN, DoCAN), and connect a channel CH2. Since the electronic control module 15-1 may support both a first protocol (e.g., Ethernet, DoIP) and the second protocol (e.g., CAN, DoCAN), the channel CH2 may be a previously connected channel according to the first protocol (e.g., Ethernet, DoIP). In this case, the edge communication node 14 may use the previously connected channel CH2 as it is, and may maintain the previously connected channel CH2.

Referring to FIG. 5A, a target communication node (to 15-3) of a received message of an edge communication node 14 may be an electronic control module 15-3, and may select the electronic control module 15-3 among communication nodes (e.g., electronic control modules 15-2, 15-3, and 15-4) that are capable of supporting a second protocol (e.g., CAN, DoCAN), and connect a channel CH5.

Referring to FIG. 6A, a target communication node (to 15-GW or 15-4) of a received message of an edge communication node 14 may be an electronic control module 15-4, and may select the electronic control module 15-4 among communication nodes (e.g., electronic control modules 15-2, 15-3, and 15-4) capable of supporting a second protocol (e.g., CAN, DoCAN) to connect the channel CH6.

The automatic channel connection operation (S15) and the selective channel connection operation (S18) may have different channel selections, and the channel selections may reduce the number of connected channels. Therefore, the number of channels (e.g., 3) connected to one of the plurality of communication nodes by the automatic channel connection operation (S15) without channel selection may be greater than the number of channels (e.g., 1) connected to one of the plurality of communication nodes by the selective channel connection operation (S18) with channel selection. Therefore, since unnecessary connection/maintenance of an unused channel may be prevented when a received message corresponding to the second protocol (e.g., CAN, DoCAN) is transmitted, an unnecessary resource usage of a vehicle network may be reduced.

FIGS. 4B, 5B, and 6B are views illustrating differences in time points of disconnection between a plurality of channels according to message reception corresponding to a second protocol of a method and an apparatus for diagnostic communication in a vehicle, according to an embodiment of the present disclosure.

Referring to FIGS. 4B, 5B, and 6B, a method for diagnostic communication in a vehicle according to an embodiment of the present disclosure may further include an operation disconnecting a channel connected in an automatic channel connection operation (S15 of FIG. 7), when the channel is not used for a predetermined time period (e.g., first time period) after a time point of connecting, by one of a plurality of communication nodes. The operation of disconnecting may include disconnecting a channel connected in a selective channel connection operation (S18 of FIG. 7), when the channel is not used for a predetermined time period (e.g., second time period) after the time point. Therefore, since unnecessary connection/maintenance of an unused channel may be reduced, an unnecessary resource of a vehicle network may be reduced. For example, the first time period and the second time period may be the same, but are not limited thereto.

Referring to FIGS. 4A and 4B, the edge communication node 14 may connect the plurality of channels CH2, CH3, and CH4 to face the control communication node 15 at substantially the same time according to the first protocol (e.g., Ethernet, DoIP). Thereafter, in the selective channel connection operation (S18 of FIG. 7), the edge communication node 14 may extend the remaining time until the disconnection of the previously connected channel CH2, when a protocol of a received message from an upper level corresponds to the second protocol (e.g., CAN, DoCAN) and there is a previously connected channel CH2 facing a lower level of the edge communication node 14. The edge communication node 14 may select the channel CH2 facing the target communication node (to 15-1) of the received message to extend a remaining time period until disconnection, and a remaining time period until disconnection of remaining channels CH3 and CH4 that are not selected may not be extended. For example, the extended remaining time may be substantially the same as the remaining time at a time point when the previously connected channel CH2 is connected, but is not limited thereto. Therefore, a remaining time period until disconnection of the remaining channels CH3 and CH4 may be shorter than a remaining time period until disconnection of the previously connected channel CH2, and thus the remaining channels CH3 and CH4 may be disconnected earlier than the previously connected channel CH2. For example, the operation of disconnecting may sequentially disconnect a plurality of channels CH2, CH3, and CH4 connected a lower level of one of the plurality of communication nodes, and disconnect up to the channel CH2 in the future, starting from a channel (CH3 and CH4) of which a remaining time period has expired. The remaining time expiration may be defined as a timeout.

Referring to FIG. 5A and FIG. 5B, since the channel CH5 connected to face the electronic control module 15-3 by the selective channel connection operation (S18 of FIG. 7) may be connected at a later time than the connection time of the plurality of channels CH2, CH3, and CH4, the channel CH5 may be disconnected at a later time than the disconnection time of the plurality of channels CH2, CH3, and CH4.

Referring to FIGS. 6A and 6B, since the channel CH6 connected to face the electronic control module 15-4 by the selective channel connection operation (S18 of FIG. 7) may be connected at a later time than the connection time of the plurality of channels CH2 and CH3, the channel CH6 may be disconnected at a later time than the disconnection time of the plurality of channels CH2 and CH3. The remaining time until the disconnection of the channel CH4 may be extended when the channel CH6 is connected to face the electronic control module 15-4, and thus the channel CH4 may be disconnected at a later time than the disconnection time of the plurality of channels CH2 and CH3.

The edge communication node 14 may identify a protocol of a received message from the external source of the vehicle 11 (e.g., vehicle diagnostic device 12), and when a protocol of a received message corresponds to a second protocol (e.g., CAN, DoCAN), may check whether there is a previously connected channel CH6 between the control gateway 15-GW and the electronic control module 15-4, and may selectively connect the channel CH6 between the control gateway 15-GW and the electronic control module 15-4 according to a check result. For example, among the plurality of communication nodes, a communication node (e.g., edge communication node 14) that executes the operation (S16) of checking may be indirectly connected to the channel CH6 by the selective channel connection operation (S18).

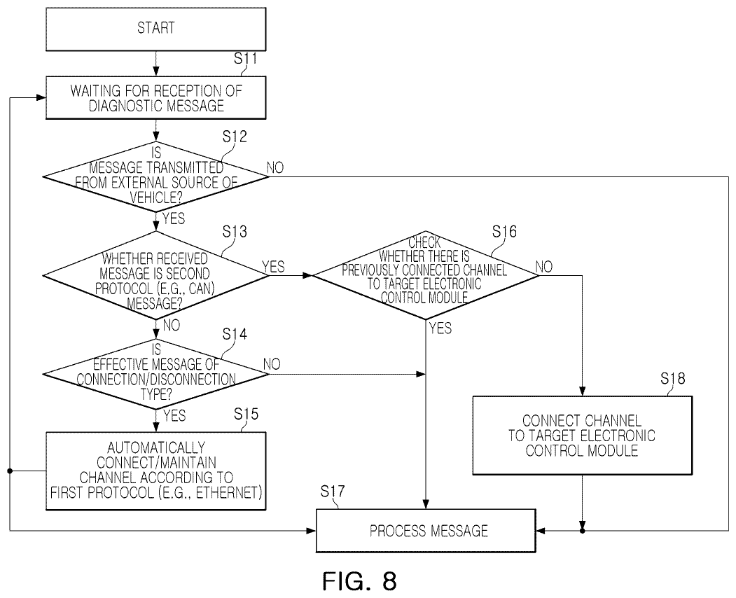

FIG. 8 is a flowchart illustrating a method for diagnostic communication in a vehicle according to an embodiment of the present disclosure.

Referring to FIG. 2A and FIG. 8, an automatic channel connection operation (S15 of FIG. 7) may include selectively automatically connecting a channel facing a lower level of one of a plurality of communication nodes, depending on whether a type of a received message received from an upper level is a type that determines whether to connect the channel (S14). For example, when a source external of a vehicle 11 (e.g., vehicle diagnostic device 12) does not transmit a message to an edge communication node 14 for a predetermined time period, a message of a type that determines whether to connect the channel (e.g., routing activation, activity check) may be transmitted to the edge communication node 14, and the edge communication node 14 may execute a channel connection procedure. Thereafter, the external source of the vehicle 11 (e.g., vehicle diagnostic device 12) may transmit a message of a different type (e.g., DoIP status, diagnostic power mode information, diagnostic message, and the like) to the edge communication node 14, and the edge communication node 14 may process the received message without an additional channel connection procedure. Therefore, unnecessary frequent execution of the channel connection procedure may be prevented, and an unnecessary resource (i.e., resource usage) of a vehicle network may be reduced.

Referring to FIG. 2A and FIG. 8, a method for diagnostic communication in a vehicle according to an embodiment of the present disclosure may further include an operation (S12) of determining whether a received message is received from an upper level or a lower level by one of a plurality of communication nodes, in a state of waiting for reception of a diagnostic message (S11). An operation (S16) of determining whether there is a previously connected channel, an operation (S18) of selectively connecting a channel, and an operation (S15) of automatically connecting a channel may be selectively executed, depending on a check result of the operation (S12). For example, even when the edge communication node 14 receives a message (e.g., vehicle identification response, vehicle announcement message) from a control communication node 15, the edge communication node 14 may not execute an additional channel connection procedure, and may perform protocol-conversion or routing for the message and transmit it to the external source of the vehicle 11 (e.g., vehicle diagnostic device 12). Therefore, unnecessary frequent execution of the channel connection procedure may be prevented, and an unnecessary resource of a vehicle network may be reduced.

Referring back to FIG. 1, a vehicle 11 according to an embodiment of the present disclosure may include a computing device 500 having a processor 501 and a storage medium 502 recording one or more programs 502a configured to be executable by the processor 501, and the one or more programs 502a may include commands for executing a method for diagnostic communication in a vehicle, according to an embodiment of the present disclosure.

The computing device 500 may include at least one processor 501, a computer-readable storage medium 502, and a communication bus 503. The communication bus 503 may interconnect various other components of the computing device 500, including the processor 501 and the computer-readable storage medium 502. For example, the computing device 500 may be implemented as a microcontroller.

The processor 501 may cause the computing device 500 to operate according to the example embodiment mentioned above. For example, the processor 501 may execute one or more programs stored on the computer-readable storage medium 502. The one or more programs 502a may include one or more computer-executable commands, which, when executed by the processor 501, may be configured to cause the computing device 500 to perform operations according to the example embodiments.

The computer-readable storage medium 502 may be configured to store a computer-executable command, a program code, a program data, and/or other suitable forms of information. A program 502a stored on the computer-readable storage medium 502 may include a set of instructions executable by the processor 501. In an embodiment, the computer-readable storage medium 502 may be a memory (volatile memory, such as random access memory, nonvolatile memory, or a suitable combination thereof), one or more magnetic disk storage devices, optical disk storage devices, flash memory devices, or any other form of storage medium that may be accessed by the computing device 500 and capable of storing desired information, or a suitable combination thereof.

The computing device 500 may also include one or more input/output interfaces 505 that provide interfaces for one or more input/output devices 504 and one or more network communication interfaces 506. The input/output interfaces 505 and the network communication interfaces 506 may be connected to the communication bus 503. The network may be any one of a cellular network, such as a global system for mobile communications (GSM), an enhanced data rates for GSM evolution (EDGE), a general packet radio service (GPRS), a code division plurality of access (CDMA), a time division-CDMA (TD-CDMA), a universal mobile telecommunications system (UMTS), a long term evolution (LTE), a 5G, a Wi-Fi, or another cellular network, and may also be implemented as Ethernet, media oriented systems transport (MOST), Flexray, a controller area network (CAN), a local interconnect network (LIN), the Internet, Bluetooth, near field Communication (NFC), Zigbee, Radio Frequency (RF), or the like.

The input/output devices 504 may be connected to other components of the computing device 500 via the input/output interface 505. Examples of the input/output devices 504 may include an input device such as a pointing device (such as a mouse, a trackpad, or the like), a keyboard, a touch input device (such as a touchpad, a touchscreen, or the like), a voice or sound input device, various types of sensor devices and/or photographing devices, and/or an output device such as a display device, a printer, a speaker, and/or a network card. Examples of the input/output devices 504 may be included in the computing device 500 as a component constituting the computing device 500, or may be connected to the computing device 500 as a separate device distinct from the computing device 500.

Embodiments of the present disclosure may include a program for performing the methods described herein on a computer, and a computer-readable recording medium including the program. The computer-readable recording medium may include a program command, a local data file, a local data structure, or the like, alone or in combination. The medium may be specially designed and configured for the present disclosure, or may be commonly used in the field of computer software. Examples of the computer-readable recording medium may include a magnetic medium such as a hard disk, a floppy disk, and a magnetic tape, an optical recording medium such as a CD-ROM or a DVD, and a hardware device specifically configured to store and execute program commands such as a ROM, a RAM, a flash memory. Examples of the programs may include not only machine language codes such as those generated by a compiler, but also high-level language codes that may be executed by the computer using an interpreter, or the like.

A method and an apparatus for diagnostic communication in a vehicle, and the vehicle including the same, according to an embodiment of the present disclosure, may provide a diagnostic environment in which the plurality of protocols for diagnosing an electronic control module may be efficiently and stably utilized by reducing unnecessary connection state maintenance of the plurality of channels or efficiently reducing overall resource usage of the vehicle network, even when the plurality of protocols (e.g., Ethernet, CAN, DoIP, DoCAN) are used for diagnosing the electronic control module.

For example, a method and an apparatus for diagnostic communication in a vehicle, and the vehicle including the same, according to an embodiment of the present disclosure, may clearly provide a connection procedure and/or a disconnection procedure of a plurality of channels, such that the plurality of channels may be efficiently used even in a vehicle network based on a plurality of protocols (e.g., Ethernet, CAN, DoIP, DoCAN), such that usage stability (e.g., operation collision prevention) and efficiency (e.g., unnecessary resource usage prevention) of the plurality of channels in the vehicle network based on the plurality of protocols (e.g., Ethernet, CAN, DoIP, DoCAN) may be effectively improved, and a separate monitoring means for determining whether to maintain channel connection may be omitted.

While example embodiments have been shown and described above, it should be apparent to those having ordinary skill in the art that modifications and variations could be made without departing from the scope of the present disclosure as defined by the appended claims.

What is claimed is:

1. A method for diagnostic communication in a vehicle, the method comprising:
an operation of checking whether there is a previously connected channel facing a lower level of one of a plurality of communication nodes according to a first protocol, by one of the plurality of communication nodes in the vehicle, when a protocol of a received message received from an upper level corresponds to a second protocol; and
a selective channel connection operation of selectively connecting a channel facing a lower level of one of the plurality of communication nodes, depending on a check result in the operation of checking, by one of the plurality of communication nodes.

2. The method of claim 1, further comprising:
an automatic channel connection operation of automatically connecting a channel to face a lower level of one of the plurality of communication nodes according to the first protocol, by one of the plurality of communication nodes; and
an operation of disconnecting a channel connected in the automatic channel connection operation when the channel is not used for a predetermined first time period after a time point of the automatic channel connection operation, by one of the plurality of communication nodes.

3. The method of claim 2, wherein the operation of disconnecting comprises disconnecting the channel connected in the selective channel connection operation when the channel is not used for a predetermined second time period after a time point of the selective channel connection operation.

4. The method of claim 3, wherein the first time period is equal to the second time period.

5. The method of claim 3, wherein, when a protocol of a received message received from an upper level of one of the plurality of communication nodes corresponds to the second protocol and there is a previously connected channel facing a lower level of one of the plurality of communication nodes, the selective channel connection operation extends a remaining time period until disconnection of the previously connected channel.

6. The method of claim 2, wherein the automatic channel connection operation comprises selectively automatically connecting a channel facing a lower level of one of the plurality of communication nodes, depending on whether a type of a received message received from an upper level of one of the plurality of communication nodes is a type that determines whether to connect the channel.

7. The method of claim 6, further comprising an operation of determining whether a received message is received from an upper level or a lower level of one of the plurality of communication nodes,
wherein the operation of checking, the selective channel connection operation, and the automatic channel connection operation are selectively performed, depending on a determination result of the operation of determining.

8. The method of claim 2, wherein a number of channels connected to a lower level of one of the plurality of communication nodes by the automatic channel connection operation is greater than a number of channels connected to a lower level of one of the plurality of communication nodes by the selective channel connection operation.

9. The method of claim 2, wherein the automatic channel connection operation comprises automatically connecting channels to all communication nodes capable of supporting the first protocol on a lower level of one of the plurality of communication nodes, and
the selective channel connection operation comprises selecting a portion of communication nodes capable of supporting the second protocol on a lower level of one of the plurality of communication nodes, and connecting a channel.

10. The method of claim 1, wherein the selective channel connection operation comprises selecting a target communication node of a received message among communication nodes capable of supporting the second protocol on a lower level of one of the plurality of communication nodes, and connecting a channel.

11. The method of claim 1, further comprising an operation of disconnecting a channel connected in the selective channel connection operation when the channel is not used for a predetermined time period after a time point of the connecting, by one of the plurality of communication nodes, and
when a protocol of a received message from an upper level of one of the plurality of communication nodes corresponds to the second protocol and there is a previously connected channel facing a lower level of one of the plurality of communication nodes, the selective channel connection operation extends a remaining time period until disconnection of the previously connected channel.

12. The method of claim 11, wherein the selective channel connection operation comprises selecting a channel facing a target communication node of a received message, among a plurality of channels connected to a lower level of one of the plurality of communication nodes, and extending a remaining time period until disconnection, and
the operation of disconnecting includes sequentially disconnecting a plurality of channels connected to a lower level of one of the plurality of communication nodes, starting from a channel of which a remaining time period has expired.

13. The method of claim 1, wherein the first protocol is based on Ethernet, and
the second protocol is based on CAN.

14. The method of claim 1, further comprising an operation of identifying a protocol of a received message received from an upper level of one of the plurality of communication nodes by one of the plurality of communication nodes.

15. An apparatus for diagnostic communication in a vehicle, the apparatus comprising:
an edge communication node configured for receiving a message from a source external of the vehicle and protocol-converting or routing the message; and
a control communication node configured for receiving the message protocol-converted or routed by the edge communication node,
wherein, when a protocol of a received message received from an upper level corresponds to a second protocol, at least one of the edge communication node or the control communication node is configured to check whether there is a previously connected channel facing a lower level according to a first protocol, and to selectively connect a channel facing a lower level, depending on a check result.

16. The apparatus of claim 15, wherein the control communication node comprises a plurality of electronic control modules, and
wherein at least one of the edge communication node or the control communication node sequentially disconnects a plurality of channels connected to the plurality of electronic control modules, starting from a channel of which a remaining time period has expired, when the channel is not used for a predetermined time period after a time point of being connected, and selects a channel connected to a target electronic control module of a received message, among the plurality of channels, to extend a remaining time period until being disconnected.

17. The apparatus of claim 15, wherein the control communication node comprises a plurality of electronic control modules, and
wherein at least one of the edge communication node or the control communication node includes selecting a target communication node of a received message among an electronic control module capable of supporting the second protocol among the plurality of electronic control modules, and connecting a channel.

18. The apparatus of claim 15, wherein the control communication node comprises a plurality of electronic control modules, and
wherein at least one of the edge communication node or the control communication node includes, when a protocol of a received message corresponds to a first protocol, automatically connecting a channel facing an electronic control module capable of supporting the first protocol among the plurality of electronic control modules, and, when a protocol of a received message corresponds to a second protocol, selecting a target communication node of a received message among an electronic control module capable of supporting the second protocol among the plurality of electronic control modules, and connecting a channel.

19. The apparatus of claim 15, wherein the control communication node comprises a control gateway connected to a lower level of the edge communication node, and an electronic control module connected to a lower level of the control gateway, and
wherein the edge communication node identifies a protocol of a received message received from a source external of the vehicle, when the protocol of the received message corresponds to the second protocol, checks whether there is a previously connected channel between the control gateway and the electronic control module, and selectively connects a channel between the control gateway and the electronic control module based on a check result.

20. A vehicle comprising:
a computing device having a processor and a storage medium storing one or more programs configured to be executable by the processor,
wherein the one or more programs include commands for executing the method of claim 1.
